(19) United States
(12) Patent Application Publication
(10) Pub. No.: US 2005/0071506 A1
(43) Pub. Date: Mar. 31, 2005

(54) System and method for mapping device context to identity context

(75) Inventor: Mark Bernard Hettish, Cary, NC (US)

Correspondence Address: Siemens Corporation;Attn: Elsa Keller, Legal Administrator, Intellectual Property Department, 170 Wood Avenue South, Iselin, NJ, 08830, US

(73) Assignee: Siemens Information and Communication Networks, Inc.

(21) Appl. No.: 10/673,522

(22) Filed: Sep. 29, 2003

(51) Int. Cl. G06F 15/16; G06F 15/173

(52) U.S. Cl. 709/245; 709/204; 709/229; 709/203; 709/224; 709/206; 709/207

(57) ABSTRACT

Embodiments provide a system, methods, apparatus, means, and computer program code for mapping a device context for a device associated with an identity to an identity context for the identity. Some embodiments also may include mapping an identity context for the identity to a device context for one or more devices associated with the identity.

### FIELD

The present invention relates to a method, system, means and computer code for mapping device context and identity context.

### BACKGROUND

A person in a multi-media or multi-channel communications system may have or use multiple devices, such as a telephone, personal digital assistant (PDA), computer, etc. Thus, the person may be represented by or associated with the different types of devices. A second person may attempt to contact the first person via email, instant message communication, telephone call, etc. The ability of the second person to contact or communicate with the first person may be limited by the availability of the device(s) chosen by the second person and/or the availability of the first person. For example, if the first person currently is using his or her telephone, the second person may not be able to contact the first person via telephone. However, the first person may be able to contact the first person via an email message sent to the first person's computer. In addition, if the first person is on vacation or out of the office, the second person may not be able to reach the first person via a telephone or computer located at the first person's office, but may be able to reach the first person via cellular telephone. As another example, if the first person is “busy,” the second person might not be able to reach the first person at all, even if all of the devices associated with the first person are currently available.

If the second person can determine the availability of the first person and/or the availability of one or more devices associated with the first person, the second person may be able to make better choices regarding how to communicate with the first person. In addition, the first person might want to change the status of availability of one or more devices associated with the first person and have such status be reflected in his or her availability. For example, if the first person establishes a “do not disturb” setting on his or her office phone, the first person may want a “do not disturb” availability to be associated with him or her as a person. In addition, the first person might want to change his or her availability status and have such change reflected in his or her availability of one or more devices associated with the first person. For example, if the first person's status goes from “in the office” to “out of the office”, the first person may want his or her office phone to be indicated as “not-available” and the first's person's cellular phone to be indicated as “available”.

As such, there is a need for a system, method, apparatus, means, and computer program code for allowing and enabling mapping of device oriented contexts to identity contexts and/or allowing mapping of identity oriented contexts to device oriented contexts.

### SUMMARY

Embodiments provide a system, method, apparatus, means, and computer program code for allowing and enabling mapping of device oriented contexts to identity contexts and/or allowing mapping of identity oriented contexts to device oriented contexts. More specifically, embodiments provide a system, method, apparatus, means, and computer program code for mapping an identity context for an identity to a device context for one or more devices associated with the identity and/or mapping a device context for one of the devices to an identity context for the identity.

In some embodiments an identity may be or include an individual person or a group of people. An identity context for an identity could be a state of “in a meeting.” “on vacation,” “in the office,” “out of the office,” “roaming,” “offline,” “online,” “in transit,” “mobile,” etc. Thus, the identify context describes the implied availability of the identity. An identity may have one or more devices associated with it. For example, a person may have an associated office telephone, a home telephone, a cellular telephone, computer, PDA, etc. Each device may have an associated device context. For example, the person's office telephone may be busy, set to “do not disturb,” automatic call forwarding, offline, etc. Context for a device may describe the work or non-work state, and/or the availability or non-availability state, that the device is in.

Additional advantages and novel features shall be set forth in part in the description that follows, and in part will become apparent to those skilled in the art upon examination of the following or may be learned by the practice of the invention.

According to some embodiments, a method may include receiving a request to make a change to new identity context for an identity; and mapping the new identity context to a device context for a device associated with the identity. In some other embodiments, a method may include detecting a new device context for a device, wherein the device is associated with an identity; and mapping the new device context to an identity context for the identity. In some further embodiments, a method may include detecting a new device context for a device in a presence and availability service, wherein the device is associated with an identity; mapping the new device context to an identity context for the identity; and providing data indicative of the identity context to an identity context oriented application. Other embodiments may include means, systems, computer code, etc. for implementing some or all of the elements of the methods described herein. With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE FIGURES

The accompanying drawings, which are incorporated in and form a part of the specification, illustrate embodiments of the invention.

FIG. 1 is a block diagram of a system according to some embodiments;

FIG. 2 is another block diagram of the system according to some embodiments;

FIG. 3 is a flowchart of a method in accordance with some embodiments;

FIG. 4 is a representative example of a mapping table for use in mapping an identity context to a device context;

FIG. 5 is another flowchart of a method in accordance with some embodiments;

FIG. 6 is another flowchart of a method in accordance with some embodiments;

FIG. 7 is another flowchart of a method in accordance with some embodiments; and

FIG. 8 is a block diagram of a server that may implement one or more of the components of FIG. 1 and/or one or more elements of the methods described herein.

### DESCRIPTION OF SPECIFIC EMBODIMENTS

There is a market opportunity for systems, means, computer code, and methods that allow and enable mapping of device oriented contexts to identity oriented contexts and/or allowing mapping of identity oriented contexts to device oriented contexts. For example, in some embodiments an identity may be or include an individual person or a group of people. An identity context for the identity could be a state of “in meeting,” “on vacation,” “in the office,” “out of the office,” “roaming,” “offline,” “online,” “unknown,” “on business trip,” “in transit,” “mobile,” etc. Thus, the identify context describes the implied availability of the identity. An identity context then may allow an identity to have an overall state that describes the work or non-work state that that the identity is in.

An identity context state of “offline” for an identity may indicate that the identity is generically offline for any number of reasons. Thus, a potential communicator with this identity should not expect to get any live contact.

An identity context state of “online” for an identity may indicate that the identity is generically online. Thus, a potential communicator with this identity could expect some chance of communicating with the identity by voice, instant messaging, etc.

An identity context state of “in meeting” for an identity may indicate that the identity is not at his or her desk, but elsewhere attending a meeting. Thus, a potential communicator with this identity might expect to be able to get voice or instant messaging contact only in urgent situations.

An identity context state of “in the office” for an identity may indicate that the identity is in his or her office. Thus, a potential communicator may be able to reach the identity via voice or instant message communication with devices in the identity's office or via an email message sent to a device in the identity's office.

An identity context state of “roaming” for an identity may indicate that the identity is in the office, but not necessarily at his or her desk. However, the identity may be available via a cellular telephone or other mobile device associated with the identity.

An identity context state of “do not disturb” or “DND” for an identity may indicate that the identity is not accepting telephone calls, instant message communications, and/or other forms of communication.

An identity context state of “in transit” for an identity may indicate that the identity is currently out of the office, away from home, and/or mobile on the way to a destination. This state also may imply that the identity has a specific mobile device (e.g., cellular telephone, PDA) and can be contacted via one or both of those devices.

An identity context state of “mobile” for an identity may indicate that the identity is working or located at a more permanent mobile environment. This context may imply that identity may be reachable via a portable or mobile device or a communication device associated with the permanent mobile environment.

In some embodiments, different applications may be used to set, monitor or change an identity context for an identity. For example, a calendar program, telephone user interface, graphical user interface, plug-in, etc. may allow or enable an identity to set or change an identity context for the identity manually or automatically.

An identity may have one or more associated devices. For example, a person may have an associated office telephone, a home telephone, a cellular telephone, computer, personal digital assistant (PDA), etc. Each device may have an associated device context. For example, the person's office telephone may be busy, set to “do not disturb,” automatic call forwarding, offline, etc. Context for a device may describe the work or non-work state, and/or the availability or non-availability state, that the device is in. In some embodiments, potential device contexts may include “available,” “non-available,” “busy,” “away,” “unknown,” “partially available” (e.g., a device may be “busy” on a voice channel but available on an instant messaging channel), “be right back,” “present,” not present,” etc. In some embodiments, different applications may be used to set, monitor or change a device context for a device. For example, software operating on a computer may allow an identity to indicate manually or automatically that the computer is unavailable for email, instant messaging, file transfer or other communications at the current time, at a specific later time, during a time range, etc. As another example, a wireless and instant messaging capable PDA may be considered as having a device context as “available” by a presence and availability service when the PDA is online and a device context of “unavailable” by the presence and availability service when the PDA is offline.

However, when an identity context changes, it may not be reflected at the device context level. Thus, while a user may set his or her identity context to, for example, “DND”, a program looking at or monitoring the devices would still believe that the identity was available for a telephone call. Mapping the identity context of “DND” to a similar device context for each of the identity's associated devices allows for a truer representation of identity context to device context oriented applications.

When a device context for a device is changed, it may represent an identity in a single media channel system. For example, in a telephone system when an identity sets his or her device context to “DND”, it means that the identity is in a state of “DND” as well. If this is the desired operation, a device context such as “DND” can be mapped to an identity context such as “DND”. Mapping the device context of “DND” to a similar identity context allows for a truer representation of identity context to identity context oriented applications.

As will be described in more detail below, there may be situations in which a change in a device context for a device associated with an identity leads to a change in an identity context for the identity, and vice versa. For example, a person may set an office telephone to “do not disturb”. Thus, the device context for the telephone is set to “do not disturb”. However, the person may be reachable or available via other devices associated with the person. In some circumstances, when the person sets the telephone to “do not disturb” (e.g., to a device context of “do not disturb” or “busy”), what the person may really want to do is reflect that he or she as an overall user is in a “do not disturb” mode. That is, his or her identity context is “do not disturb” and, as a result, the person is not reachable or availability via any of the devices associated with the person. When the person sets the telephone to “do not disturb,” software in the telephone, or another application monitoring the state of the telephone, may indicate to a context agent that the telephone's device context has changed.

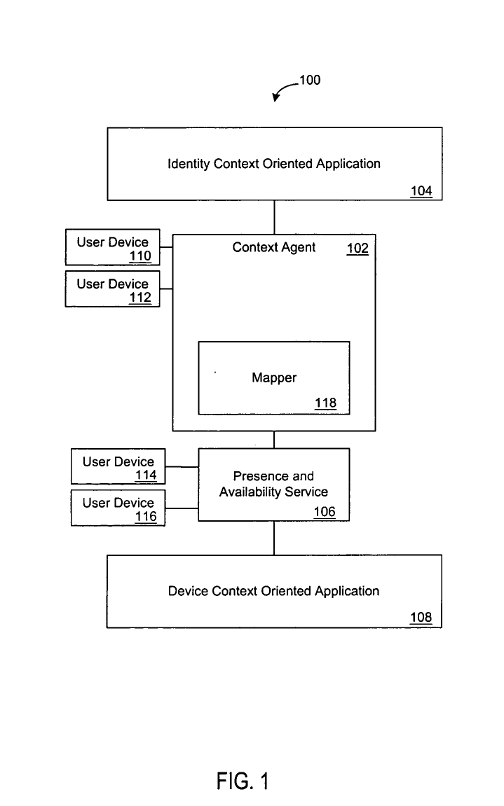

Now referring to FIG. 1, an exemplary system 100 is illustrated according to some embodiments. The system 100 includes a context agent 102 that may be connected to or in communication with an identity context oriented application 104 and a presence and availability service 106. The system 100 also may include a device context oriented application 108 connected to or in communication with the presence and availability service 106.

User devices, such as the user devices 110, 112, may be connected to or in communication with the context agent 102. Similarly, user devices, such as user devices 114, 116, may be connected to or in communication with the presence and availability service 106. In some embodiments, a user device may be or include such things as telephones, cellular telephones, PDAs, computers, etc. For example, the user devices 114, 116, may be personal computers implementing the Windows XP™ operating system and the Windows Messenger™ instant messenger system. In addition, the user devices 114, 116 may include telephony and other multimedia messaging capability using, for example, peripheral cameras, Webcams, microphones and speakers (not shown) or peripheral telephony handsets, such as the Optipoint™ handset available from Siemens Information and Communication Networks.

In some embodiments, the system 100 may include other hardware and/or software components (e.g., gateways, proxy servers, registration servers, presence servers, redirect servers, databases, applications), such as, for example, hardware and software used to support a SIP or other protocol based infrastructure for the system 100 and allow registration of SIP devices in the system 100.

The context agent 102 may monitor the identity context of one or more identities and/or the device context of one or more devices. In some embodiments, the context agent 102 may provide or include an application interface that supports identity context, device context, device presence, and/or other functions. Applications may monitor, access and/or query the context agent 102 for identity context and/or device context information.

In some embodiments, the context agent 102 may be able to receive, retrieve, or otherwise obtain information regarding an identity and/or a device associated with the identity, such as calendar information, schedule information, location information, configuration information, context information, etc.

In some embodiments, the context agent 102 may provide the information to the identity context oriented application 104 upon request, periodically, or in accordance with some other plan or procedure. In addition, in some embodiments, the context agent 102 may provide information regarding device context. For example, an application may query the context agent 102 to monitor or determine the device context of one or more devices. In some embodiments, an application may set or request a change for, either an identity context and/or a device context. For example, an application that sets an identity context for an identity to “in meeting” may set the device context for the identity's desk telephone to “offline” for both voicemail and instant messaging.

The context agent 102 may be implemented in hardware and/or software operating on one or more servers, computer systems, host or mainframe computers, workstations, etc. In some embodiments the context agent 102 may be operating on some or all of the same device(s) as other components in the system 100.

As will be discussed in more detail below, in some embodiments the context agent 102 may include or be in communication with a mapper component 118 that allows the context agent 102 to map device context information for a device (e.g., the user device 114) to identity context information for an identity associated with the device. The context agent 102 then may provide updated or new identity context information for the identity to the identity context oriented application 104. In addition, the mapper 118 may map identity context information for an identity to device context information for one or more devices associated with the identity. The context agent 102 then may provide the updated or new device context information for the device to the presence and availability service 106.

In some embodiments, the mapper 118 may be implemented as part of the context agent 102. In other embodiments, the mapper 118 may be implemented separately from the context agent 102 and be in communication with both the context agent 102 and the presence and availability service 106. In such embodiments, the mapper 118 may be implemented in hardware and/or software operating on one or more servers, computer systems, host or mainframe computers, workstations, etc. and may be operating on some or all of the same device(s) as other components in the system 100 instead of the context agent 102.

The identity context oriented application 104 may be or include an application that uses, collects, refers to, etc. information regarding the identity context of one or more identities. For example, an identity context oriented application may be or include software that allows identities to provide information regarding their availability, location, etc. In some embodiments, a user device, server, host or mainframe computer, workstation, etc. may include an identity context oriented application or have one operating or residing on it. The identity context oriented application 104 may be implemented in hardware and/or software operating on one or more servers, computer systems, host or mainframe computers, workstations, etc. In some embodiments the identity context oriented application 104 may be operating on some or all of the same device(s) as other components in the system 100.

The presence and availability service 106 may be or include an application that monitors the presence and availability of devices. That is, the presence and availability service 106 monitors the device context of one or devices. In some embodiments, one or more of the devices may be associated with the identities whose context is used or monitored by the identity context oriented application 104. The presence and availability service 106 may be implemented in software operating on one or more servers, computer systems, host or mainframe computers, workstations, etc. In some embodiments the presence and availability service 106 may be operating on some or all of the same device(s) as other components in the system 100.

In some embodiments, the presence and availability service 106 may be or include an application that communicates with or is connected to one or more registered devices (e.g., devices 114, 116), that allows devices to register with the system 100 or helps facilitate their registration, etc. For example, in a SIP environment, the devices 114, 116 may be registered with the system 100 and may show up or be described in registration databases as being assigned to particular identities. The context agent 102 may register with the presence and availability service 106 and receive device context and/or other information from the presence and availability service regarding the devices 114, 116.

In some embodiments, the presence and availability service 106 may provide device context information to the device context oriented application 108 upon request, periodically, or in accordance with some other plan or procedure. In some embodiments, the presence and availability service may implement an instant messaging system. For example, the instant messaging system may be embodied as Microsoft Windows Messenger™ software or other instant messaging system.

The device context oriented application 108 may be or include an application that uses, collects, refers to, etc. information regarding the device context of one or more device (e.g., the user device 114). For example, a device context oriented application may be or include software that allows identities to provide or request information regarding the availability of devices associated with the identities, etc. In some embodiments, a user device, server, host or mainframe computer, workstation, etc. may include a device context oriented application or have one operating or residing on it. The device context oriented application 108 may be implemented in hardware and/or software operating on one or more servers, computer systems, host or mainframe computers, workstations, etc. In some embodiments the device context oriented application 108 may be operating on some or all of the same device(s) as other components in the system 100.

The terms “identity context,” “device context,” “context agent,” “mapper,” “presence and availability service,” “identity context oriented application,” and “device context oriented application” are used herein merely for purposes of convenience and ease of explanation and no specific limitations are intended or implied by the use of these terms herein.

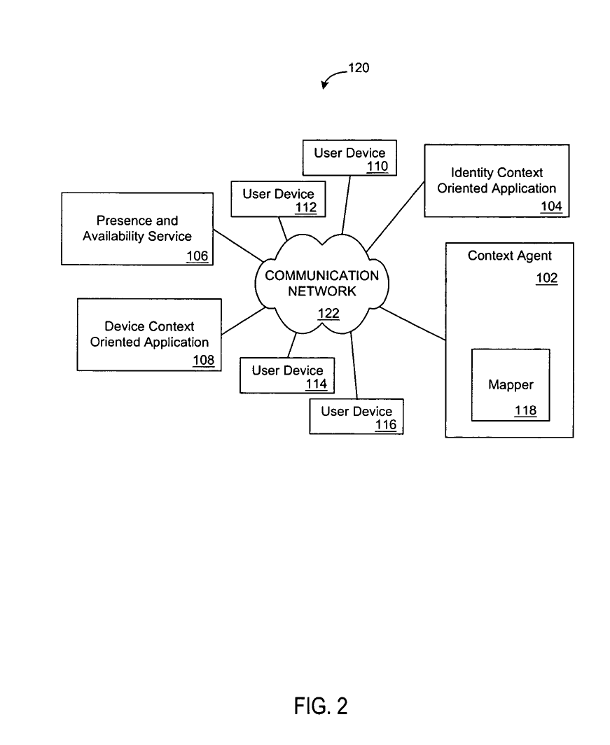

In some embodiments, one or more of the components of the system 100 may be connected or in communication with each other via a communication network. For example, now referring to FIG. 2, a system 120 including the components of the system 100 is illustrated, wherein some or all of the components are in communication via a network 122. The network 122 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

Process Description

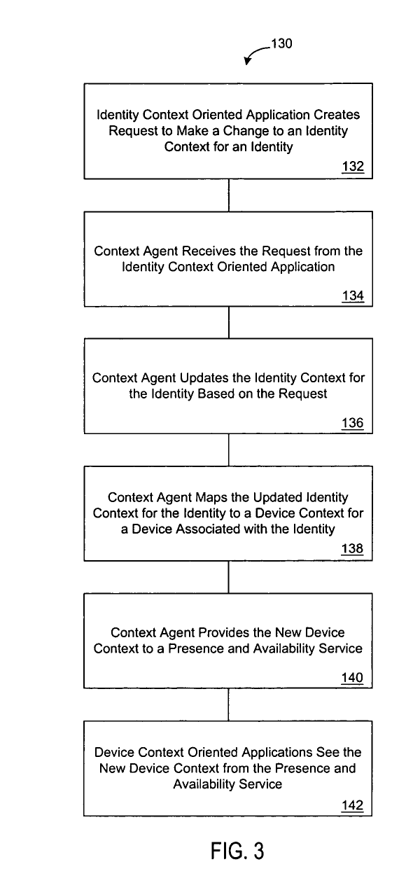

Reference is now made to FIG. 3, where a flow chart 132 is shown which represents the operation of a first embodiment. The method 132 is particularly well suited for situations where an identity context for an identity is to be mapped to a device context for one or more devices associated with the identity. The particular arrangement of elements in the flow chart 132 is not meant to imply a fixed order to the elements; embodiments can be practiced in any order that is practicable.

Processing begins at 132 during which the identity context oriented application 104 creates a request to make a change to an identity context for an identity. For example, an identity context may change from “in the office” to “in a meeting” or from “online” to “offline”.

In some embodiments, the identity context oriented application 104 may create the request based on the action of an identity, other application, communication received from a user device, etc. The identity context oriented application 104 may provide the request directly or indirectly to the context agent 102.

During 134, the context agent 102 receives or otherwise obtains the request created by the identity context oriented application 104. The request may be or include data, a data stream or other communication signal receivable or obtainable by the context agent 102.

During 136, the context agent 102 updates the identity context for the identity based on the request. The context agent 102 may store some or all of the identity context information in a local or remote database, file, log, or other electronic resource.

During 138, the context agent 102 maps the updated identity context for the identity to a device context for one or more devices (e.g., the user device 110 or the user device 114) associated with the identity. As previously discussed above, in some embodiments, the context agent 102 may include or have access to the mapper component 118 to conduct such mapping or other conversion.

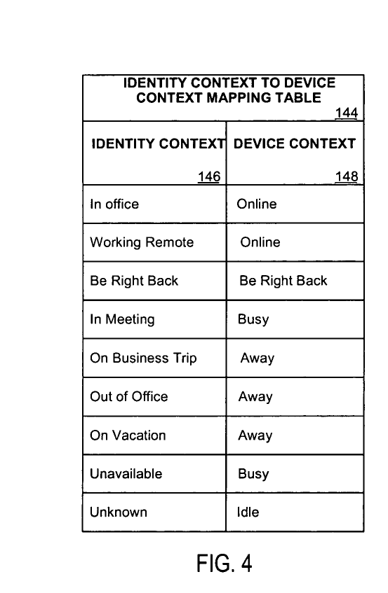

In some embodiments, the context agent 102 may have access to or use a mapping table or other resource that indicates the mapping of an identity context to a device context. For example, as illustrated in mapping table 144 in FIG. 4, identity contexts listed in column 146 may be mapped to corresponding device contexts in column 148 for one or more devices associated with the identity. More specifically, if an identity context changes from “in office” to “out of office” for an identity, a device context for a device should be mapped to “away” based on the new identity context of “out of office”.

In some embodiments, mapping of device context to identity context, and vice versa, may be done in other ways. For example, a system administrator may establish, update, modify, etc. one or more mapping tables. As another example, an identity or group of identities may establish, update, modify, etc. one or more mapping tables. As a third example, a system administrator, identity, group, etc. may establish one or more rules, heuristics, procedures, algorithms, etc. for establishing or using a mapping table, for using one or more inputs or retrieved data to create a mapping table, etc.

In some embodiments, mapping an identity context to a device context may vary for different devices associated with an identity. For example, an identity context of “out of office” may be mapped to “away” for a computer at the identity's office and “online” for a wireless PDA associated with the identity. Thus, different devices may use different identity context to device context mapping tables, conventions, or rules.

In some embodiments, if different mapping tables, conventions, or rules are used for difference devices, the context agent 102 may need to identity or determine one or more devices associated with the identity in order to change their device context properly. In some embodiments, if only one type of device is assumed to be associated with an identity, if multiple types of devices can have the same device contexts, if the context agent 102 does not know the device for which it is mapping an identity context, or if is not feasible for the context agent 102 to know or determine the types of devices that may be associated with an identity, a default mapping table or convention may be used to map the identity context to a device context. Thus, the context agent 102 may not need to determine the specific type of device.

Referring back to FIG. 3, during 140, the context agent 102 provides information or other data regarding the device context for the device to the presence and availability service 106, which may be or include the presence and availability service 106 “seeing,” retrieving, querying, requesting, accessing, or otherwise obtaining the device context information from the context agent 102. As previously mentioned above, the presence and availability service 106 may be or include an application that monitors the presence and availability of devices and, as a result, monitors the device context of one or devices.

After receiving the new device context information from the context agent 102, the presence and availability service 106 may update its device context information. This may result in a change in the device context previously associated with the device associated with the identity whose identity context changed. For example, if an identity context changes from “in office” to “out of office”, a device context for a device associated with the identity may change from “online” to “away”.

In some embodiments, the presence and availability service 106 may provide information regarding the new device context to a device context oriented application, such as the device context oriented application 108 or a device context oriented application operating on a user device (e.g., the user device 114) or another device.

During 142, a device context oriented application, such as the device context oriented application 108 or a device context oriented application operating on a user device (e.g., the user device 114) or another device, may “see”, retrieve, query, obtain, or otherwise have access to some or all of the updated device context information managed by the presence and availability service 106.

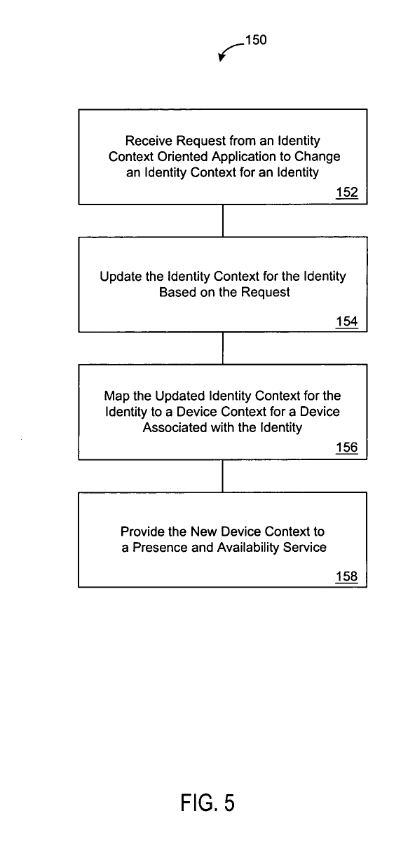

Reference is now made to FIG. 5, where a flow chart 150 is shown which represents the operation of a second embodiment. The particular arrangement of elements in the flow chart 150 is not meant to imply a fixed order to the elements; embodiments can be practiced in any order that is practicable. In some embodiments, some or all of the elements of the method 150 may be performed or completed by the context agent 102.

Processing begins at 152 during which the context agent 102 receives or otherwise obtains a request from an identity context oriented application (e.g., identity context oriented the application 104) to change an identity context for an identity.

During 154, the context agent 102 updates or otherwise modifies the identity context for the identity based on the request.

During 156, the context agent 102 maps the updated identity context for the identity to one or more device contexts for one or more devices associated with the identity. In some embodiments, the context agent 102 may need to identity or otherwise determine one or more device associated with the identity, use or access a default or other mapping table, and/or identity or otherwise determine a device context associated with one or more devices that are associated with the identity.

In some embodiments, during 158, the context agent 102 may provide some or all of the new device context information to the presence and availability service 106 or allow the presence and availability service 106 to “see,” retrieve, access, query, request or otherwise obtain the device context information.

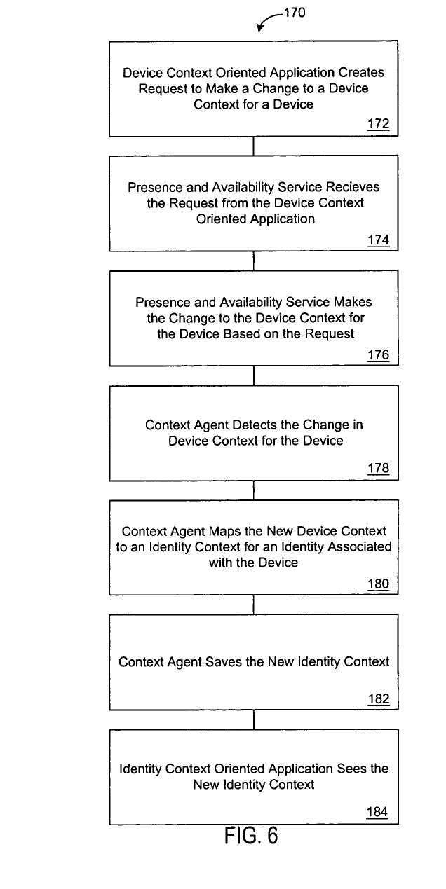

Reference is now made to FIG. 6, where a flow chart 170 is shown which represents the operation of a third embodiment. The method 170 is particularly well suited for situations where a device context for a device associated with an identity is to be mapped to an identity context for the identity. The particular arrangement of elements in the flow chart 170 is not meant to imply a fixed order to the elements; embodiments can be practiced in any order that is practicable.

Processing begins at 172 during which the device context oriented application 108 creates a request to make a change to a device context for a device (e.g., the user device 114) associated with an identity. For example, the device context may change from “online” to “busy” or from “online” to “away”. For example, monitoring software, which may be acting as a device context oriented application, may monitor the state of one or more telephones and report changes in the states to the context agent 102 or another application (e.g., the context oriented device application). Instant messaging applications may update the states of one or more devices via the presence and availability service 106.

In some embodiments, the device context oriented application 108 may create the request based on the action of an identity, other application, communication received from a user device, etc. The device context oriented application 108 may provide the request directly or indirectly to the presence and availability service 106.

During 174, the presence and availability service 106 receives or otherwise obtains the request created by the device context oriented application 108. The request may be or include data, a data stream or other communication signal receivable or obtainable by the presence and availability service 106.

During 176, the presence and availability service 106 updates the device context for the device based on the request. The presence and availability service 106 may store some or all of the device context information in a local or remote database, file, log, or other electronic resource.

During 178, the context agent 102 detects or otherwise “sees” the change in the device context for the device. In some embodiments, the context agent 102 may receive a request from the presence and availability service 106 to change a device context. In other embodiments, the context agent 102 may monitor the presence and availability service 106 for changes in device contexts. In still other embodiments, the presence and availability service 106 may provide data to the context agent 102 indicative of a change in device context for one or more devices.

During 180, the context agent 102 maps the new or different device context for the device to an identity context for the identity associated with the device. If a device context changes from “online” to “offline” for an identity, an identity context for the associated identity could be mapped to “unavailable”. As previously discussed above, in some embodiments, the context agent 102 may include, use, or have access to the mapper component 118 to conduct such mapping or other conversion.

In some embodiments, the context agent 102 may have access to or use a mapping table that indicates the mapping of a device context to an identity context, in a manner similar to mapping table 144 illustrated in mapping table 144 in FIG. 4. In some embodiments, mapping a device context to an identity context may vary for different devices associated with an identity. Thus, different devices may use different identity context to device context mapping tables.

During 182, the context agent 102 may store or otherwise save the new identity context information. For example, in some embodiments, the context agent 102 may store some or all of the identity context information in a local or remote database, file, log, or other electronic resource.

During 184, an identity context oriented application, such as the identity context oriented application 104 or an identity context oriented application operating on a user device (e.g., the user device 110) or another device, may “see”, retrieve, or otherwise have access to some or all of the updated identity context information managed by the context agent 102. In some embodiments, the context agent 102 may provide information or other data regarding the identity context to another device or application, which may be or include the other device or application retrieving, querying, requesting, accessing, or otherwise obtaining the identity context information from the context agent 102.

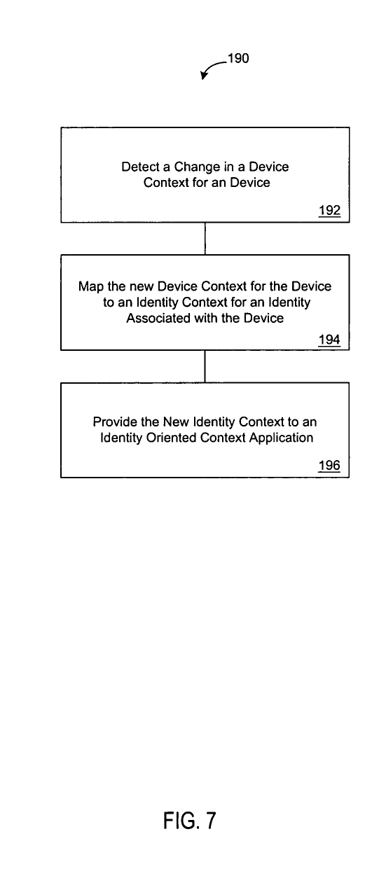

Reference is now made to FIG. 7, where a flow chart 190 is shown which represents the operation of a fourth embodiment. The particular arrangement of elements in the flow chart 190 is not meant to imply a fixed order to the elements; embodiments can be practiced in any order that is practicable. In some embodiments, some or all of the elements of the method 150 may be performed or completed by the context agent 102.

Processing begins at 192 during which the context agent 102 detects a change in a device context for a device, as previously discussed above.

During 194, the context agent 102 maps the new or changed device context to an identity context for an identity associated with the device. In some embodiments, different identities may use different mapping tables, rules, or conventions. In some embodiments, different device contexts for different devices may have different identity context associated with them. In some embodiments, the context agent may need to determine the identity, the identity contexts available for or usable with the identity, the appropriated mapping table, rule(s) or convention, etc.

During 196, the context agent 102 may provide some or all of the new identity context information to an identity context oriented application to allow an identity context oriented application to “see”, retrieve, access, query, request or otherwise obtain the identity context information.

Server

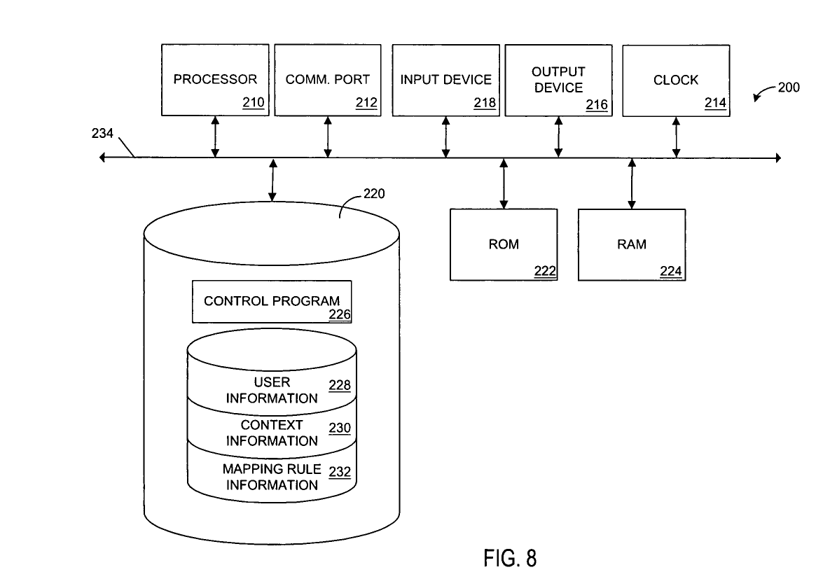

Now referring to FIG. 8, a representative block diagram of a server or controller 200 is illustrated. In some embodiments, the server 200 may include or operate an identity context oriented application, a device context oriented application, the context agent 102, the mapper 118, and/or the presence and availability service 106. The server 200 can comprise a single device or computer, a networked set or group of devices or computers, a workstation, mainframe or host computer, etc. In some embodiments, the server 200 may implement one more elements of the methods disclosed herein.

The server 200 may include a processor, microchip, central processing unit, or computer 210 that is in communication with or otherwise uses or includes one or more communication ports 212 for communicating with user devices and/or other devices. Communication ports may include such things as local area network adapters, wireless communication devices, Bluetooth technology, etc. The server 200 also may include an internal clock element 214 to maintain an accurate time and date for the server 200, create time stamps for communications received or sent by the server 200, etc.

If desired, the server 200 may include one or more output devices 216 such as a printer, infrared or other transmitter, antenna, audio speaker, display screen or monitor, text to speech converter, etc., as well as one or more input devices 218 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 200 may include a memory or data storage device 220 to store information, software, databases, documents, communications, device drivers, etc. The memory or data storage device 220 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 200 also may include separate ROM 222 and RAM 224.

The processor 210 and the data storage device 220 in the server 200 each may be, for example: (i) located entirely within a single computer or other computing device; or (ii) connected to each other by a remote communication medium, such as a serial port cable, telephone line or radio frequency transceiver. In one embodiment, the server 200 may comprise one or more computers that are connected to a remote server computer for maintaining databases.

A conventional personal computer or workstation with sufficient memory and processing capability may be used as the server 200. The server 200 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 210. Equivalent or other processors may be available from Motorola, Inc., AMD, or Sun Microsystems, Inc. The processor 210 also may comprise one or more microprocessors, computers, computer systems, etc.

Software may be resident and operating or operational on the server 200. The software may be stored on the data storage device 220 and may include a control program 226 for operating the server, databases, etc. The control program 226 may control the processor 210. The processor 210 preferably performs instructions of the control program 226, and thereby operates in accordance with the methods described in detail herein. The control program 226 may be stored in a compressed, uncompiled and/or encrypted format. The control program 226 furthermore includes program elements that may be necessary, such as an operating system, a database management system and device drivers for allowing the processor 210 to interface with peripheral devices, databases, etc. Appropriate program elements are known to those skilled in the art, and need not be described in detail herein.

The server 200 also may include or store information regarding identities, user devices, contexts, mapping tables, communications, etc. For example, information regarding one or more identities may be stored in an identity information database 228 for use by the server 200 or another device or entity. Information regarding one or more identity or device contexts may be stored in a context information database 230 for use by the server 200 or another device or entity and information regarding one or more context mapping rules may be stored in a context mapping information database 232 for use by the server 200 or another device or entity. In some embodiments, some or all of one or more of the databases may be stored or mirrored remotely from the server 200.

According to some embodiments, the instructions of the control program may be read into a main memory from another computer-readable medium, such as from the ROM 222 to the RAM 224. Execution of sequences of the instructions in the control program causes the processor 210 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 210, communication port 212, clock 214, output device 216, input device 218, data storage device 220, ROM 222, and RAM 224 may communicate or be connected directly or indirectly in a variety of ways. For example, the processor 210, communication port 212, clock 214, output device 216, input device 218, data storage device 220, ROM 222, and RAM 224 may be connected via a bus 234.

While specific implementations and hardware/software configurations for the server 200 have been illustrated, it should be noted that other implementations and hardware configurations are possible and that no specific implementation or hardware/software configuration is needed. Thus, not all of the components illustrated in FIG. 8 may be needed for the server 200 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although methods and systems have been described with respect to various embodiments thereof, those skilled in the art will note that various substitutions may be made to those embodiments described herein. The invention described in the above detailed description is not intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method, comprising the steps of:
detecting a new device context for a device, wherein said device is associated with an identity; and
mapping said new device context to an identity context for said identity.

2. The method of claim 1, wherein said step of detecting said new device context for said device includes detecting said new device context in a presence and availability service.

3. The method of claim 1, wherein said step of detecting said new device context for said device includes receiving a request to change said device's device context.

4. The method of claim 1, wherein said step of mapping said new device context to said identity context for said identity includes determining said identity.

5. The method of claim 1, wherein said step of mapping said new device context to said identity context for said identity includes determining said identity context.

6. The method of claim 1, further comprising the step of:
determining said identity.

7. The method of claim 1, further comprising the step of:
determining said identity context.

8. The method of claim 1, further comprising the step of:
providing data indicative of said identity context.

9. The method of claim 8, wherein said step of providing data indicative of said identity context includes providing said data indicative of said identity context to an identity context oriented application.

10. The method of claim 1, further comprising the step of:
receiving a request to make a change to new identity context for an identity; and
mapping said new identity context to a device context for a device associated with said identity.

11. The method of claim 1, further comprising the step of:
receiving a request to make a change to new identity context for a second identity; and
mapping said new identity context to a device context for a device associated with said second identity.

12. The method of claim 11, wherein said step of receiving said request to make said change to new identity context for said second identity includes receiving said request from an identity context oriented application.

13. The method of claim 11, wherein said step of mapping said new identity context to said device context for said device associated with said second identity includes determining said device associated with said second identity.

14. The method of claim 13, wherein said step of mapping said new identity context to said device context for said device associated with said second identity includes determining said device context associated with said device associated with said second identity.

15. The method of claim 11, wherein said step of mapping said new identity context to said device context for said device associated with said second identity includes accessing a mapping table.

16. The method of claim 1, further comprising the step of:
providing data indicative of said device context to a presence and availability service.

17. The method of claim 11, further comprising the step of:
changing an identity context for said second identity from a first context to a said new context in response to said request.

18. A method, comprising the steps of:
detecting a new device context for a device in a presence and availability service, wherein said device is associated with an identity;
mapping said new device context to an identity context for said identity;
providing data indicative of said identity context to an identity context oriented application.

19. An article of manufacture comprising:
a computer readable medium having stored thereon instructions which, when executed by a processor, cause said processor to:
detect a new device context for a device, wherein said device is associated with an identity; and
map said new device context to an identity context for said identity.

20. An apparatus, including:
a processor;
a communication port coupled to said processor and adapted to communicate with at least one device; and
a storage device coupled to said processor and storing instructions adapted to be executed by said processor to:
detect a new device context for a device, wherein said device is associated with an identity; and
map said new device context to an identity context for said identity.
